(19) United States
(12) Patent Application Publication
(10) Pub. No.: US 2023/0119891 A1
(43) Pub. Date: Apr. 20, 2023

(54) TIER GROUPING AND EXCHANGE SYSTEM

(71) Applicant: IGT, Las Vegas, NV (US)

(72) Inventors: Patrick DANIELSON, Las Vegas, NV (US); Vincent S. LAI, Las Vegas, NV (US)

(73) Assignee: IGT

(21) Appl. No.: 17/501,025

(22) Filed: Oct. 14, 2021

(51) Int. Cl. G07F 17/32

(52) U.S. Cl. CPC G07F 17/3281; G07F 17/3244; G07F 17/3225

(57) ABSTRACT

Systems, devices and methods are operable to include tier grouping and exchange systems. A mobile device includes a processor circuit and a memory coupled to the processor circuit, the memory comprising machine readable instructions that, when executed by the processor circuit, cause the processor circuit to perform specific operations. Such operations include receiving, from a server, a first award that is based on player data in a first player reward account, transmitting an offer to transfer a portion of the first award to a second mobile device that is associated with a second player, receiving, from the second mobile device, an acceptance to receive the portion of the first award, and responsive to receiving the acceptance, causing the portion of the first award to be transmitted to the second mobile device.

### BACKGROUND OF THE DISCLOSURE

Players in casinos may have different levels of engagement with gambling opportunities. Additionally, even at similar levels of engagement, players may experience different levels of success. Different levels of engagement and/or success may result in a divergence in benefits and/or incentives that casinos may award players. For example, a highly engaged and/or highly successful player may receive benefits and/or incentives that are not offered to less engaged players. Such divergence may render the benefits and/or incentives as less attractive since multiple parties in a group may have different benefit and/or incentive opportunities.

### BRIEF SUMMARY OF THE DISCLOSURE

Provided herein is a server that includes a processor circuit and a memory coupled to the processor circuit. The memory includes machine readable instructions that, when executed by the processor circuit, cause the processor circuit to operate to convey, to a first player of multiple players, a first award that is based on player data in a first player reward account and transmit award data that corresponds to the first award to a mobile device that is associated with the first player. The processor circuit may further receive, via the mobile device, a request to transfer a portion of the first award to a second player of the multiple players, wherein the second player includes a second award that is less than the first award, to convey, to the second player, the portion of the first award and to transmit the portion of the award data to a second mobile device that is associated with the second player.

Some embodiments are directed to a computer implemented that includes operations of transmitting, to a first mobile device that is associated with a first player of multiple players, a first award that is based on player data in a first player rewards account, receiving, via the first mobile device, a request to transfer a portion of the first award to a second mobile device that is associated with a second player, and transmitting, to the second mobile device, the portion of the first award to the second mobile device.

Some embodiments are directed to a mobile device that includes a processor circuit and a memory coupled to the processor circuit. The memory includes machine readable instructions that, when executed by the processor circuit, cause the processor circuit to operate to receive, from a server, a first award that is based on player data in a first player reward account, transmit an offer to transfer a portion of the first award to a second mobile device that is associated with a second player, receive, from the second mobile device, an acceptance to receive the portion of the first award, and responsive to receiving the acceptance, cause the portion of the first award to be transmitted to the second mobile device.

### BRIEF DESCRIPTION OF SEVERAL VIEWS OF THE DRAWINGS

FIG. 1 is a schematic block diagram illustrating a network configuration for gaming devices according to some embodiments.

FIG. 2 is a schematic block diagram illustrating an electronic configuration for a points exchange server according to some embodiments.

FIGS. 3A-3D are flow diagrams illustrating data flows according to some embodiments.

FIGS. 4-6 are flowcharts illustrating operations of systems/methods according to some embodiments.

### DETAILED DESCRIPTION OF THE DISCLOSURE

Embodiments of the inventive concepts provide that allowing player sharable tier credits and/or points, such as those corresponding to player reward programs and/or other metrics corresponding to player engagement with the casino, may provide such players the opportunity to include other parties. Specifically, some embodiments provide that sharable tier credits may be shared using a mobile device to normalize the benefits for couples, friends and/or family.

For example, in some embodiments, it allows instantaneous access to allow multiple players to help one another rise up to a common tier ranking for benefits and access. In one example, a husband and wife play with their individual player card and hope to get to Platinum (Silver, Gold, Platinum). However, in a given trip, the husband may play to earn 80K points and may achieve Gold (over 50K points). The wife may have only earned 40K points and thus may not qualify for the benefits corresponding to the Gold tier. According to some embodiments herein, the husband may gift/debit 10K points to his wife to help normalize her status to Gold via a mobile app. In this manner, both can then enjoy better comps, discounts for gifts and food, etc. together as Gold tier. Both husband and wife may still have to earn the same delta to get to higher status, but both may feel encouraged by this sharing of tiers.

In some embodiments, a player tracking system may allow multiple people and/or accounts to be associated with a single account. For example, each of multiple people may have their own individual account and each of those individual accounts may be associated with different joint account that is accessible by all of the multiple people.

Some embodiments provide that a player tracking system allows multiple people have their own individual accounts that are associated with ones of the other individual accounts. In some embodiments, each of the individual accounts includes a community portion that is accessible to the other individual accounts and a private portion that is only accessible to the associated account owner. Some embodiments provide that the multiple accounts may be connected to one another to share or gift points from one or more accounts with other ones of the multiple accounts.

In some embodiments, the group dynamics could change based on predetermined point usage commitments. Some embodiments provide that the redemption of points in a community account may be determined on a first come, first serve basis by all participants. In some embodiments, points may be redeemed based on the approval of one or more other members. Some embodiments provide that all earned points may be divided evenly among all participants. Such embodiments may only apply to specific sessions that may be limited or may be a substantially permanent arrangement that lasts until one or more participants changes the term. In some embodiments, only earned points may be available to share and/or gift. Some embodiments provide may provide that the gifting of points between accounts may be required an/or automatic corresponding to one or more triggers.

In some embodiments, metrics may be applied to allow competing members to keep track of the amounts wagered, won, and/or bonus points amount awarded. In some embodiments, accounts can be configured as main accounts where the points and perks are combined and/or sub-accounts of a main account. Account management and linking may be performed using a mobile application that is operated on a mobile device.

In some embodiments, a first player may be in the highest tier and may desire to share benefits and/or status with a second player. The first player may log into a mobile application according to systems and methods herein and identify a quantity and/or type of gift points to be send to the second player. The first player may also identify the second player as the intended recipient of the gift points. Using the mobile application, the amount and type of gift points may be transferred from the first player to the second player so the second player can enjoy the benefits that the first player is eligible for.

In some embodiments, a group of players want to equally share all points that are received and/or earned. In some embodiments, before any of the group of players can use the earned points, one or more of the other players must provide an approval of the use before anyone can use the points. For example, one of the group of players may want to use some of the points for dinner. In such embodiments, a notification may be sent to the mobile devices of each of player in the group of players. In response, several of the players in the group may cause an approval to be sent for the requesting play to use the points for dinner.

Some embodiments provide that a system herein may allow say a high stakes player (e.g., a “whale”) who has no time to enjoy sold out concerts, dinner, and other comps. The high stakes player may use the system to exchange his points for access to the other comps for others such as family, friends, clients, and/or coworkers, among others. For example, the high stakes player may exchange points for printout of admission tickets for others to use.

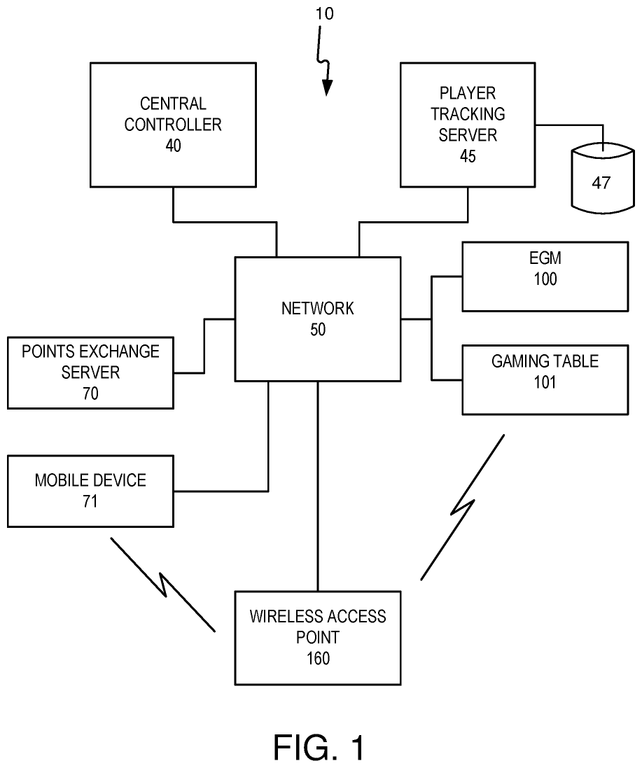

Referring to FIG. 1, a gaming system 10 including an EGM 100 is illustrated. The gaming system 10 may be located, for example, on the premises of a gaming establishment, such as a casino. The EGM 100, which may typically be situated on a casino floor, may be in communication with other EGMs 100 and/or at least one central controller 40 through a data network or remote communication link 50. The data communication network 50 may be a private data communication network that is operated, for example, by the gaming facility that operates the EGM 100.

The gaming system 10 may include a table game 101 that may typically be situated on a casino floor, may be in communication with EGMs 100, other table games 101 and/or at least one central controller 40 through a data network or remote communication link 50. Table games 101 may include conventional wagering table games that may be configured to track and store player activity during a gaming session and/or electronic table games (ETG) that include one or more processors and interact with the player via displays and/or user interfaces.

Communications over the data communication network 50 may be encrypted for security. The central controller 40 may be any suitable server or computing device which includes at least one processor and at least one memory or storage device. Each EGM 100 and/or table game 101 may include a processor that transmits and receives events, messages, commands or any other suitable data or signal between the EGM 100 and/or table game 101 and the central controller 40. The EGM processor or table game processor is operable to execute such communicated events, messages or commands in conjunction with the operation of the EGM 100 and/or table game 101. Moreover, the processor of the central controller 40 is configured to transmit and receive events, messages, commands or any other suitable data or signal between the central controller 40 and each of the individual EGMs 100 and/or table games 101. In some embodiments, one or more of the functions of the central controller 40 may be performed by one or more EGM and/or table game processors. Moreover, in some embodiments, one or more of the functions of one or more EGM processors and/or table game processors as disclosed herein may be performed by the central controller 40.

A wireless access point 160 provides wireless access to the data communication network 50, the mobile device 71 and/or other system components such as the gaming table 101, the EGM 100, the points exchange server 70 and/or the player tracking server 45, among others. The wireless access point 160 may be connected to the data communication network 50 as illustrated in FIG. 1 or may be connected directly to the central controller 40 or other servers connected to the data communication network 50. Some embodiments provide that the player tracking server 45 and the points exchange server 70 may be on different servers. In some embodiments, the player tracking server 45 and the points exchange server 70 may be provided in the same server.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

In some embodiments, the gaming system 10 includes a points exchange server 70. The points exchange server 70 may be a computing system that communicates through the data communication network 50 with a mobile device 71, the player tracking server 45, EGM 100, gaming table 101 and/or a vendor 72. The mobile device 71 may include one or more personal computing devices, such as laptop computers, tablet computers or computing devices, personal digital assistants (PDAs), mobile telephones such as smart phones, and other mobile computing devices.

In some embodiments, the mobile device 71 may communicate with the points exchange server 70 to transmit exchange data corresponding to points and/or credits in a player tracking system from the mobile device 71 to the points exchange server 70. The exchange data may include data corresponding to points that may be gifted and/or shared among multiple players. The points exchange server 70 may provide opportunities to share points that may result in a player gaining a higher tier than their player points would otherwise provide.

In some embodiments, the exchange data is received from the mobile device 71 that is associated with the user. The exchange data may be based on mobile device 71 usage corresponding to a software application that is unrelated to the gaming opportunity.

In some embodiments, the exchange data is received from the user, via one or more software applications that are on the mobile device 71. In such embodiments, the software applications may receive the data that is used to determine the exchange data from the user. Some embodiments provide that the exchange data includes historical data that is received from the user via the software applications over a given period of time. For example, the historical data may be gathered and/or aggregated before the user interest data is received by the points exchange server 70 from the mobile device 71. In some embodiments, whether an item of the historical data includes the exchange data may be based on the quantity of times that the item of the historical data has been received during the given period of time. For example, an item of historical data may be identified as exchange data if that item of historical data has been received in greater quantities and/or with greater frequency than other data.

In some embodiments, the exchange data includes recently received data that is received from the user by the mobile device 71. For example, the recently received data may indicate an increased interest by the user based on the recency corresponding to the recently received data.

In some embodiments, receiving the exchange data may cause a request for the exchange data to be sent from the points exchange server 70 to the mobile device 71 and receiving the exchange data into the points exchange server 70 responsive to the mobile device 71 receiving the request. In some embodiments, the exchange data may include updated exchange data. For example, previously received exchange data may be updated with exchange data that is more recent. In some embodiments, updating the exchange data may include replacing older, less relevant data with more recent data. In some embodiments, updating the exchange data may include aggregating recently received exchange data with previously received exchange data.

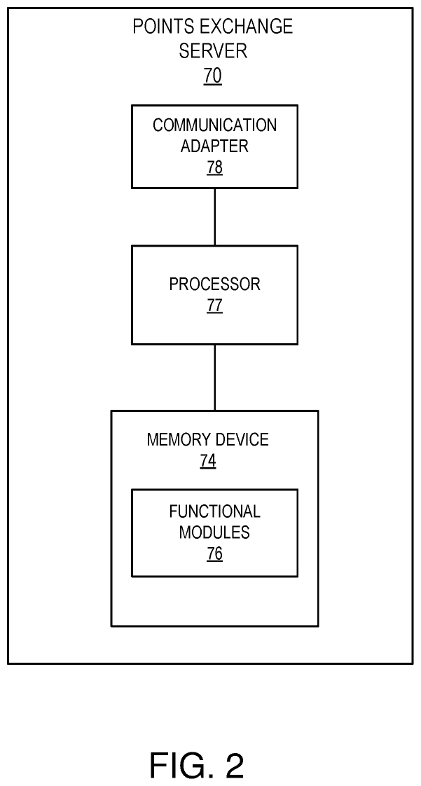

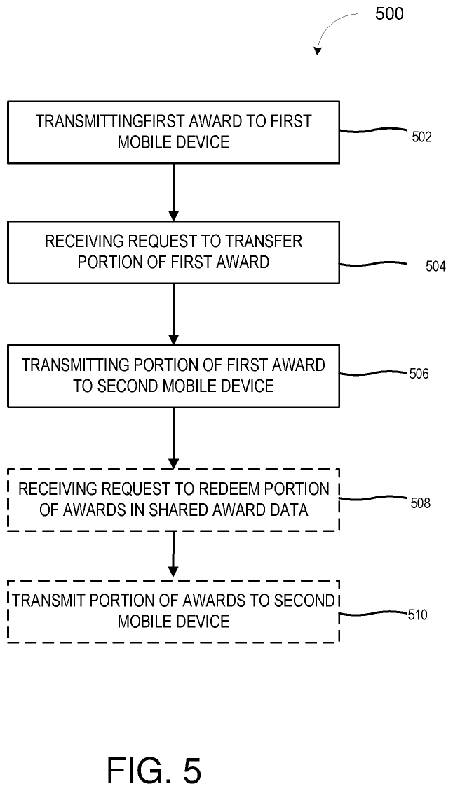

Reference is now made to FIG. 2, which is a block diagram that illustrates various components of a points exchange server 70 according to some embodiments. As shown in FIG. 5, the mobile targeting server 70 may include a processor 77 that controls operations of the points exchange server 70. Although illustrated as a single processor, multiple special purpose and/or general purpose processors and/or processor cores may be provided in the mobile targeting server 70. For example, the points exchange server 70 may include one or more of a video processor, a signal processor, a sound processor and/or a communication controller that performs one or more control functions within the points exchange server 70. The processor 77 may be variously referred to as a “controller,” “microcontroller,” “microprocessor” or simply a “computer.” The processor may further include one or more application-specific integrated circuits (ASICs).

Various components of the points exchange server 70 are illustrated in FIG. 5 as being connected to the processor 77. It will be appreciated that the components may be connected to the processor 77 through a system bus, a communication bus and controller, such as a USB controller and USB bus, a network interface, or any other suitable type of connection.

The points exchange server 70 further includes a memory device 74 that stores one or more functional modules 76 for performing the operations described above.

The memory device 74 may store program code and instructions, executable by the processor 77, to control the points exchange server 70. The memory device 74 may include random access memory (RAM), which can include non-volatile RAM (NVRAM), magnetic RAM (ARAM), ferroelectric RAM (FeRAM) and other forms as commonly understood in the gaming industry. In some embodiments, the memory device 74 may include read only memory (ROM). In some embodiments, the memory device 74 may include flash memory and/or EEPROM (electrically erasable programmable read only memory). Any other suitable magnetic, optical and/or semiconductor memory may operate in conjunction with the gaming device disclosed herein.

The points exchange server 70 may include a communication adapter 78 that enables the mobile targeting server 70 to communicate with remote devices, such as EGMs 100 and/or a player tracking server 45 (FIG. 1) over a wired and/or wireless communication network, such as a local area network (LAN), wide area network (WAN), cellular communication network, or other data communication network.

The points exchange server 70 may include one or more internal or external communication ports that enable the processor 77 to communicate with and to operate with internal or external peripheral devices, such as display screens, keypads, mass storage devices, microphones, speakers, and wireless communication devices. In some embodiments, internal or external peripheral devices may communicate with the processor through a universal serial bus (USB) hub (not shown) connected to the processor 77.

Although illustrated and discussed as a separate device, some embodiments provide that the points exchange server 70 and some or all of the components therein may be implemented in the central controller 40 (FIG. 1) and/or the player tracking server 45 (FIG. 1).

In various embodiments, the gaming system includes one or more player tracking systems under control of the player tracking server 45 (FIG. 1). Some embodiments provide that such tracking systems may be used to provide data to the mobile device 71 and/or the points exchange server 70. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. Some embodiments provide that such information and/or data may be used in combination with the user interest data that may be received from the mobile device 71. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

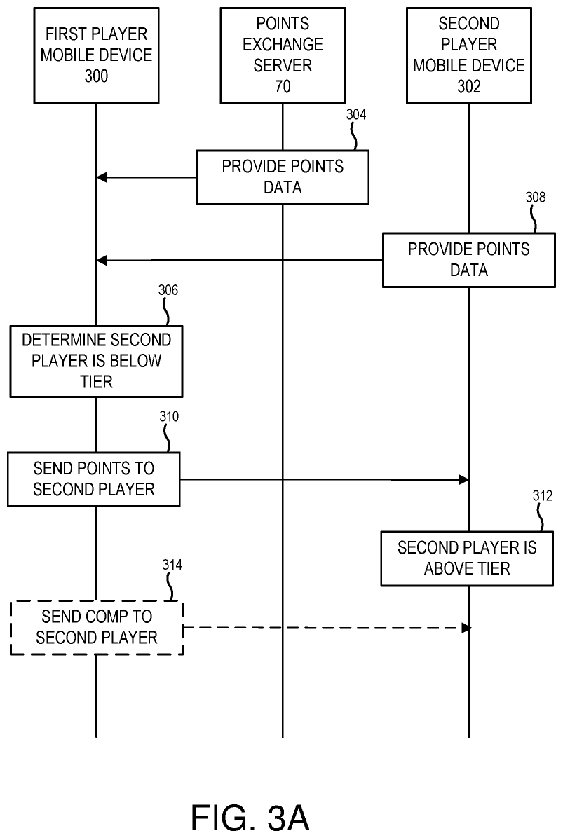

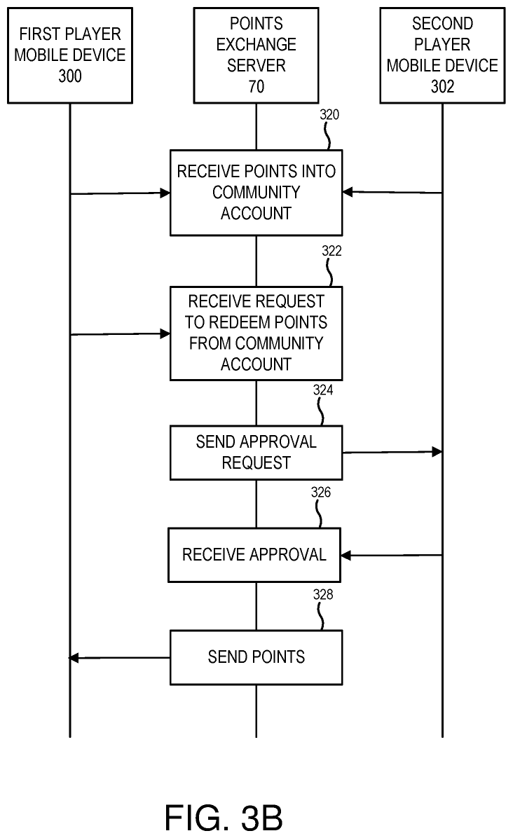

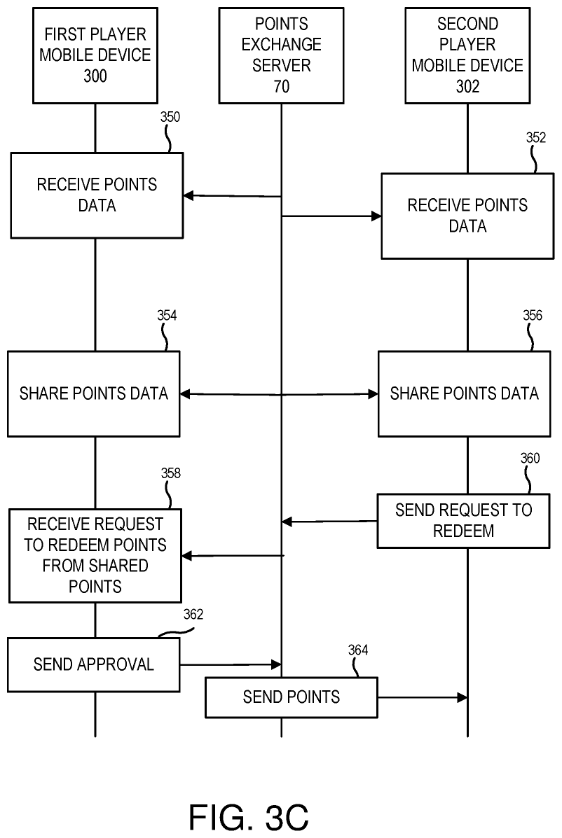

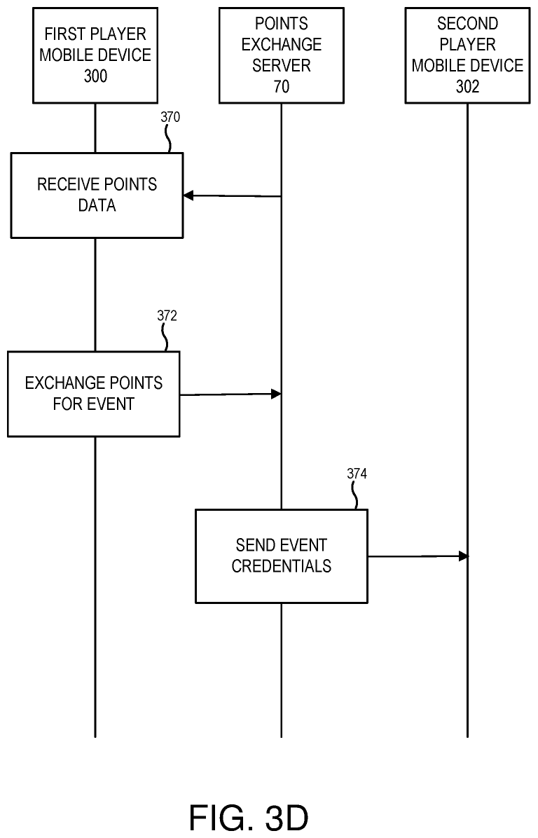

FIGS. 3A-3D are flow diagrams illustrating data flows according to some embodiments. Referring to FIG. 3A, a first player mobile device 300 may be configured to exchange data with a points exchange server 70 and/or a second player mobile device 302. For example, according to some embodiments, the points exchange server 70 is configured to provide points data (block 304) to the first player mobile device 300. Some embodiments provide that the points data may include data corresponding to a points balance in reward points program and/or data corresponding to different tiers of benefits that correspond to different points amounts.

In some embodiments, the first player mobile device 300 may receive points data corresponding to the second player from the second player mobile device 302 and/or from the points exchange server 70. The first player mobile device 300 may determine (block 306) that the second player has an amount of points that is below the number of points needed to quality for a given tier that the first player may have already been given. Responsive to the second player having insufficient points to quality for the tier of benefits that the first player qualifies for, the first player may send (block 310) points to the second player mobile device 302. As a result, the points received from the first player may cause the second player to have sufficient points to be above the tier threshold and thus be eligible to receive benefits corresponding to the tier.

In some embodiments, the first player may have a specific benefit based on the amount of points or other activities in the casino. Such complimentary benefits (“comps”) may include free meals, shows and/or other attractions. Some embodiments provide that the first player may send (block 314) a comp to the second player.

Referring to FIG. 3B, a points exchange server 70 may be configured to receive (block 320) points from the first player mobile device 300 and from the second player mobile device 302. In some embodiments, the points may be received into a community account that is operable to maintain points data correspond to multiple players in a group of players.

The points exchange server 70 may receive (block 322) a request from one of the player ins the group to redeem points from the community account. In some embodiments, the request must be approved by some portion of the other players in the group. In such embodiments, an approval request may be sent (block 324) to one or more of the other players in the group. An approval may be received (block 326) and the points may be sent (block 328) to the requesting player.

Referring to FIG. 3C, some embodiments provide that individual points accounts may be shared among players in a group of players. In such embodiments, the mobile devices 300, 302 may receive (blocks 350, 352) from the points exchange server 70 and/or from other ones of the player mobile devices. Points data may be share (blocks 354, 356) with each of the players in the player group and/or with the points exchange server 70.

A player may send (block 360) a request to the points exchange server 70 to redeem points from the shared points of the group of players. In response, each of the other players in the player group may receive (block 358) a request for approval to redeem points from the shared points. One or more to the players in the group of players may send (block 362) approval and the points exchange server 70 may send and/or cause to be sent (block 364) the points that were requested.

Referring to FIG. 3D, some embodiments are directed to the exchange of points and/or tiers that are earned by high volume/high stakes player, which may be referred to as “whales” and/or “high rollers”. In such embodiments, the first player mobile device 300 may be the device associated with the whale and may receive points data from a points exchange server 70. The first player may exchange (block 372) points for complimentary events for other players and the event credential may be sent (block 374) to the other players.

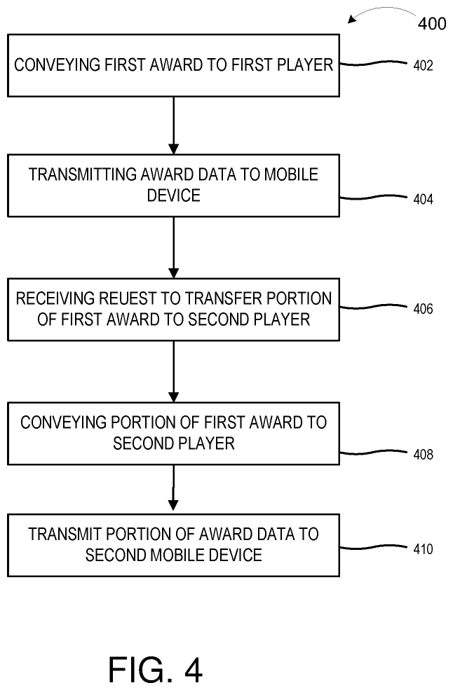

Reference is now made to FIG. 4, which is a flowchart illustrating operations of systems/methods according to some embodiments. In some embodiments, operations include conveying (block 402) a first award that is based on player data in a first player reward account to a first player of multiple players. Award data that corresponds to the first award is transmitted (block 404) to a mobile device that is associated with the first player. A request to transfer a portion of the first award is received (block 406), via the mobile device. In some embodiments, a request to transfer a portion of the first award to a second player of the multiple players is received. In some embodiments, the second player includes a second award that is less than the first award.

Operations include conveying (block 408), to the second player, the portion of the first award and transmitting (block 410) the portion of the award data to a second mobile device that is associated with the second player.

In some embodiments, a second award that is less than the first award is conveyed to the second player. In some embodiments, the first award, the portion of the first award and the second award include points in a casino rewards program.

In some embodiments, the first award includes a first service tier level eligibility that includes a first plurality of services that are available to the first player and the second award includes a second service tier level eligibility that includes a second plurality of services that are available to the second player. In some embodiments, the first plurality of services includes more value than the second plurality of services and, responsive to receiving the portion of the first award, the second player is eligible to receive the first service tier level eligibility.

In some embodiments, the first award exceeds an award threshold, the second award is below the award threshold, and operations further include determining that a revised award for the second player includes the second award and the portion of the first award, and that the revised award exceeds the award threshold.

In some embodiments, each of the players is associated with one of multiple reward accounts that includes award data for each of the players. In some embodiments, all of the players are associated with a shared reward account that includes shared award data that includes collected awards from the players. In some embodiments, operations include receiving, from the second player of the players, a request to redeem a portion of collected awards that corresponds to the shared award data and to transmit the portion of collected awards including the shared award data to the second mobile device that is associated with the second player. In some embodiments, responsive to receiving the request to redeem the portion of the collected awards that corresponds to the shared reward account, operations further transmit a request for authorization from another one of the players to transmit the portion of collected awards to the second player.

Some embodiments include receiving the authorization from the other one of the players in response to the request for authorization and transmitting the portion of collected awards including the shared award data to the second mobile device that is associated with the second player is performed responsive to receiving the authorization. In some embodiments, each of the reward accounts includes a first account portion that is associated with the shared reward account and a second account portion that is not associated with the shared reward account.

In some embodiments, the first player rewards account is related to player data corresponding to all of the group of players operations include transmitting the portion of the award data to the second mobile device.

Some embodiments provide that the first player is remotely located from the second player and the portion of the first award includes an award that is redeemed without the first player.

In some embodiments, the portion of the first award includes admission to an event that the first player does not attend.

Reference is now made to FIG. 5, which is a flowchart illustrating operations of systems/methods according to some embodiments. In some embodiments, operations include transmitting (block 502), to a first mobile device that is associated with a first player of a group of players, a first award that is based on player data in a first player rewards account. Operations include receiving (block 504), via the first mobile device, a request to transfer a portion of the first award to a second mobile device that is associated with a second player. Operations include transmitting (block 506), to the second mobile device, the portion of the first award to the second mobile device.

In some embodiments, the transmitting includes transmitting, via the second mobile device and to the second player, a second award that is less than the first award. In some embodiments, the first award exceeds an award threshold, the second award is below the award threshold and operation further include determining that a revised award for the second player includes the second award and the portion of the first award, and the revised award exceeds the award threshold.

In some embodiments, the first award includes a first service tier level eligibility that includes a first set of services that are available to the first player and the second award includes a second service tier level eligibility that includes a second set of services that are available to the second player based on the second award. In some embodiments, the first set of services includes a greater value value than the second set of services. Some embodiments provide that, responsive to receiving the portion of the first award, the second player is eligible to receive the first service tier level eligibility.

In some embodiments, each of the group of players is associated with one of multiple reward accounts that include award data for each of the group of players. Some embodiments provide that, all of the players are associated with a shared reward account that includes shared award data that includes collected awards from the group of players. In some embodiments, operations optionally include receiving (block 508), from the second player of the group of players, a request to redeem a portion of the collected awards that corresponds to the shared award data and transmitting (block 510) the portion of the collected awards including the shared award data to the second mobile device that is associated with the second player.

In some embodiments, responsive to receiving the request to redeem the portion of the collected awards that corresponds to the shared reward account, operations include transmitting a request for an authorization from an other one of the group of players to transmit the portion of the collected awards to the second player, receiving the authorization from the other one of the group of players in response to the request for authorization, and transmitting the portion of the collected awards including the shared award data to the second mobile device that is associated with the second player in responsive to receiving the authorization.

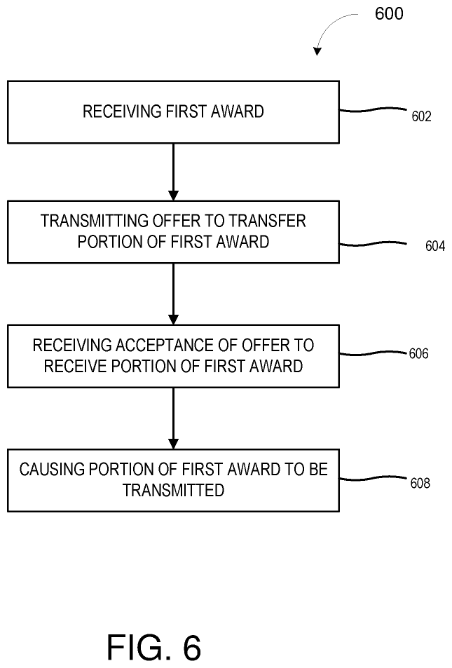

Reference is now made to FIG. 6, which is a flowchart illustrating operations of systems/methods according to some embodiments. In some embodiments, operations include receiving (block 602), from a server, a first award that is based on player data in a first player reward account and transmitting (block 604) an offer to transfer a portion of the first award to a second mobile device that is associated with a second player. Operations include receiving (block 606), from the second mobile device, an acceptance to receive the portion of the first award and, responsive to receiving the acceptance, causing (block 608) the portion of the first award to be transmitted to the second mobile device.

### Player Tracking

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

As noted above, a player's progress or status can be saved in other ways besides using a player tracking system, such as by generating, when the player cashes out, a ticket including a printed code, such as a bar code or QR code, that identifies the player's session. When the player wants to continue the game, the player may insert the ticket including the printed code into the bill/ticket acceptor of an EGM (which may or may not be the same EGM from which the ticket was issued). The EGM reads the printed code and retrieves the player's status in response to the printed code.

### EGM Features

Embodiments described herein may be implemented in various configurations for EGMs, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to a EGM local processing circuit and memory devices. In such a “thick client” embodiment, the EGM local processing circuit executes the communicated computerized instructions to control any games (or other suitable interfaces) provided to a player.

In some embodiments, an EGM may be operated by a mobile device, such as a mobile telephone, tablet other mobile computing device. For example, a mobile device may be communicatively coupled to an EGM and may include a user interface that receives user inputs that are received to control the EGM. The user inputs may be received by the EGM via the mobile device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processing circuit of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

Embodiments provided herein may provide improved accessibility to wagering stations by including additional user interface technologies, such as augmented reality. Such embodiments may improve technological efficiency by coordinating the augmented reality with examples of different types of wagering stations.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A server comprising:
a processor circuit; and
a memory coupled to the processor circuit, the memory comprising machine readable instructions that, when executed by the processor circuit, cause the processor circuit to operate to:
convey, to a first player of a plurality of players, a first award that is based on player data in a first player reward account;
transmit award data that corresponds to the first award to a mobile device that is associated with the first player;
receive, via the mobile device, a request to transfer a portion of the first award to a second player of the plurality of players, wherein the second player comprises a second award that is less than the first award;
convey, to the second player, the portion of the first award; and
transmit the portion of the award data to a second mobile device that is associated with the second player.

2. The server of claim 1, wherein the processor circuit is further caused to convey, to the second player, a second award that is less than the first award.

3. The server of claim 2, wherein the first award, the portion of the first award and the second award comprise points in a casino rewards program.

4. The server of claim 2, wherein the first award comprises a first service tier level eligibility that comprises a first plurality of services that are available to the first player,
wherein the second award comprises a second service tier level eligibility that comprises a second plurality of services that are available to the second player,
wherein the first plurality of services comprises more value than the second plurality of services, and
wherein, responsive to receiving the portion of the first award, the second player is eligible to receive the first service tier level eligibility.

5. The server of claim 2,
wherein the first award exceeds an award threshold,
wherein the second award is below the award threshold,
wherein the processor circuit further determines that a revised award for the second player comprises the second award and the portion of the first award, and
wherein the revised award exceeds the award threshold.

6. The server of claim 1,
wherein each of the plurality of players is associated with one of a plurality of reward accounts that comprises award data for each of the plurality of players,
wherein all of the plurality of players are associated with a shared reward account that comprises shared award data that comprises collected awards from the plurality of players.

7. The server of claim 6, wherein the processor circuit operates to receive, from the second player of the plurality of players, a request to redeem a portion of collected awards that corresponds to the shared award data and to transmit the portion of collected awards comprising the shared award data to the second mobile device that is associated with the second player.

8. The server of claim 7, wherein, responsive to receiving the request to redeem the portion of the collected awards that corresponds to the shared reward account, the processor circuit is further caused to transmit a request for authorization from an other one of the plurality of players to transmit the portion of collected awards to the second player.

9. The server of claim 8, wherein the processor circuit is further caused to receive the authorization from the other one of the plurality of players in response to the request for authorization, and
wherein transmitting the portion of collected awards comprising the shared award data to the second mobile device that is associated with the second player is performed responsive to receiving the authorization.

10. The server of claim 6, wherein each of the plurality of reward accounts comprises a first account portion that is associated with the shared reward account and a second account portion that is not associated with the shared reward account.

11. The server of claim 1,
wherein the first player rewards account is related to player data corresponding to all of the plurality of players, and
wherein the processor circuit is further caused to transmit the portion of the award data to the second mobile device.

12. The server of claim 1, wherein the first player is remotely located from the second player, and
wherein the portion of the first award comprises an award that is redeemed without the first player.

13. The server of claim 1, wherein the portion of the first award comprises admission to an event that the first player does not attend.

14. A computer implemented method, comprising:
transmitting, to a first mobile device that is associated with a first player of a plurality of players, a first award that is based on player data in a first player rewards account;
receiving, via the first mobile device, a request to transfer a portion of the first award to a second mobile device that is associated with a second player; and
transmitting, to the second mobile device, the portion of the first award to the second mobile device.

15. The method of claim 14, further comprising transmitting, via the second mobile device and to the second player, a second award that is less than the first award.

16. The method of claim 15, wherein the first award exceeds an award threshold,
wherein the second award is below the award threshold,
wherein the method further determines that a revised award for the second player comprises the second award and the portion of the first award, and
wherein the revised award exceeds the award threshold.

17. The method of claim 15, wherein the first award comprises a first service tier level eligibility that comprises a first plurality of services that are available to the first player,
wherein the second award comprises a second service tier level eligibility that comprises a second plurality of services that are available to the second player based on the second award,
wherein the first plurality of services comprises more value than the second plurality of services, and
wherein, responsive to receiving the portion of the first award, the second player is eligible to receive the first service tier level eligibility.

18. The method of claim 14, wherein each of the plurality of players is associated with one of a plurality of reward accounts that comprises award data for each of the plurality of players,
wherein all of the plurality of players are associated with a shared reward account that comprises shared award data that comprises collected awards from the plurality of players,
wherein the method further comprises receiving, from the second player of the plurality of players, a request to redeem a portion of the collected awards that corresponds to the shared award data and transmitting the portion of the collected awards comprising the shared award data to the second mobile device that is associated with the second player.

19. The method of claim 18, wherein, responsive to receiving the request to redeem the portion of the collected awards that corresponds to the shared reward account, the method further comprises:
transmitting a request for an authorization from an other one of the plurality of players to transmit the portion of the collected awards to the second player;
receiving the authorization from the other one of the plurality of players in response to the request for authorization; and
transmitting the portion of the collected awards comprising the shared award data to the second mobile device that is associated with the second player is performed responsive to receiving the authorization.

20. A mobile device comprising:
a processor circuit; and
a memory coupled to the processor circuit, the memory comprising machine readable instructions that, when executed by the processor circuit, cause the processor circuit to operate to:
receive, from a server, a first award that is based on player data in a first player reward account;
transmit an offer to transfer a portion of the first award to a second mobile device that is associated with a second player;
receive, from the second mobile device, an acceptance to receive the portion of the first award; and
responsive to receiving the acceptance, cause the portion of the first award to be transmitted to the second mobile device.
